(19) United States
(12) Patent Application Publication
(10) Pub. No.: US 2011/0000222 A1
(43) Pub. Date: Jan. 6, 2011

(54) GAS TURBINE ROTOR-STATOR SUPPORT SYSTEM

(75) Inventors: Kenneth Damon Black, Travelers Rest, SC (US); Ian David Wilson, Simpsonville, SC (US); Bradley James Miller, Simpsonville, SC (US); Henry Grady Ballard, JR., Easley, SC (US)

Correspondence Address: CANTOR COLBURN LLP, 20 Church Street, 22nd Floor, Hartford, CT, 06103, US

(73) Assignee: GENERAL ELECTRIC COMPANY, Schenectady, NY (US)

(21) Appl. No.: 11/848,898

(22) Filed: Aug. 31, 2007

(51) Int. Cl. F02C 7/20

(52) U.S. Cl. 60/796

(57) ABSTRACT

A system to support a rotor and a stator of a rotating machine disposed upon a support base, the system including at least one support leg in operable communication with a bearing of the rotor and with the support base; and at least one strut in operable communication with the at least one support leg and with the stator.

### BACKGROUND OF THE INVENTION

1. Field of the Invention

The invention disclosed herein relates to the field of turbines and, in particular, to turbine support system architecture.

2. Description of the Related Art

A gas turbine includes many heavy components that require support. Supports are used to support the weight of the gas turbine, accommodate vibration, and keep the gas turbine anchored in place.

The gas turbine includes a rotor that rotates within a stator. The rotor is supported by bearings, which transfer a load to a bearing housing or similar non-rotating support system. The housing or support structure is generally located interior to the annular flow of exhaust gases. In conventional support structure architectures, the bearing housing or similar support structure is generally supported by struts that span the annular flow of exhaust gases. The struts are secured to an outer structure, exterior to the annular flow of exhaust gases, that is attached to the remainder of the stator. In turn, the stator is secured to a support structure that provides support in the vertical and horizontal planes.

Several disadvantages may exist with this type of gas turbine support system architecture. One disadvantage is that conventional support structures have to accommodate vibration interaction between the rotor and the stator. An increase in clearance between a set of turbine blades and the stator may be needed to accommodate the vibration. The increase in clearance usually results in a decrease in efficiency of the gas turbine.

Another disadvantage is that an increased load may be imposed on stator case flanges during emergency loading conditions such as seismic events or loss of rotating hardware. The increased load is transferred to the supports. To support the increased load, the stator case flanges may require more mass. An increase in mass of the stator case flanges can cause uneven heating of the stator. Uneven heating of the stator can lead to out-of-roundness and may cause rubbing of the turbine blades. In addition, the increased load may cause the stator flanges to slip resulting in a need for realignment.

Therefore, what are needed are techniques for supporting a gas turbine that accommodate vibration and reduce emergency loading of the stator case flanges. Such techniques are disclosed herein.

### BRIEF DESCRIPTION OF THE INVENTION

Disclosed is an embodiment of a system to support a rotor and a stator of a rotating machine disposed upon a support base, the system including at least one support leg in operable communication with a bearing of the rotor and with the support base; and at least one strut in operable communication with the at least one support leg and with the stator.

Also disclosed is an embodiment of a rotating machine disposed upon a support base, the machine including a stator; a rotor disposed adjacent to the stator; a rotor bearing in operable communication with the rotor; at least one support leg in operable communication with the bearing and with the support base; and at least one strut in operable communication with the at least one support leg and with the stator.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings, wherein like elements are numbered alike, in which:

FIG. 1 illustrates an exemplary embodiment of a gas turbine;

FIG. 2 illustrates an end view of an exemplary embodiment of the gas turbine;

FIG. 3 illustrates a three dimensional view of an exemplary embodiment of the gas turbine; and

FIGS. 4A and 4B, collectively referred to as FIG. 4, illustrates an exemplary embodiment of the gas turbine with one support leg and a lateral support structure.

### DETAILED DESCRIPTION OF THE INVENTION

The teachings provide embodiments of a support system for supporting a rotor and a stator of a gas turbine. The support system accommodates vibration and reduces emergency loading on stator case flanges. In one embodiment, the support system includes support legs for supporting the rotor from a foundation. The support system also supports the stator using struts. Static and dynamic forces imposed on the stator are transferred by the struts to the support legs. By supporting the stator from a rotor support, concentricity of the rotor with respect to the stator may be maintained.

For convenience, certain definitions are provided. The term “rotating machine” relates to machinery that includes blades disposed circumferentially about a shaft. The shaft and blades rotate together to at least one of compress a gas, pump a fluid, convert a fluid flow to rotational work, and convert a gas flow to rotational work. The term “gas turbine” relates to a rotating machine that is a continuous combustion engine. The gas turbine generally includes a compressor, a combustion chamber and a turbine. The compressor compresses air for combustion in a combustion chamber. The combustion chamber emits hot gases that are directed to the turbine. The turbine converts the energy of the hot gases to rotational work. The term “rotor” relates to a rotating structure such as the turbine. The rotor includes a shaft and a set of blades disposed circumferentially about the shaft. The term “casing” relates to a structure surrounding the rotor. The casing may also be referred to as a “stator.” The term “stator case flange” relates to a flange on the casing used to secure sections of a casing together. The term “turbine stage” relates to a plurality of turbine blades disposed circumferentially about a section of a turbine shaft. The turbine blades of the turbine stage are arranged in a circular pattern about the shaft. The term “clearance” relates to an amount of distance between the outside tip of one turbine blade and the casing. The term “rotor bearing” relates to a bearing for supporting the rotor. The term “bearing housing” relates to a housing for supporting a bearing. The term “inner barrel” relates to a generally cylindrical structure internal to the casing. The inner barrel may be used to support the bearing housing. The term “support leg” relates to a support for supporting the rotor. One end of the support leg may be attached to a support base external to the casing. Another end of the support leg may be attached to the inner barrel or a structure for supporting the bearing such as the bearing housing. The term “strut” relates to a support internal to the casing. One end of the strut may be secured to the casing. Another end of the strut may be secured to the inner barrel or the bearing housing. The strut may be used to support the casing from at least one of the inner barrel, the bearing housing, and the support leg. The term “rubbing” relates to at least one turbine blade making contact with the casing. Rubbing generally causes damage to the gas turbine.

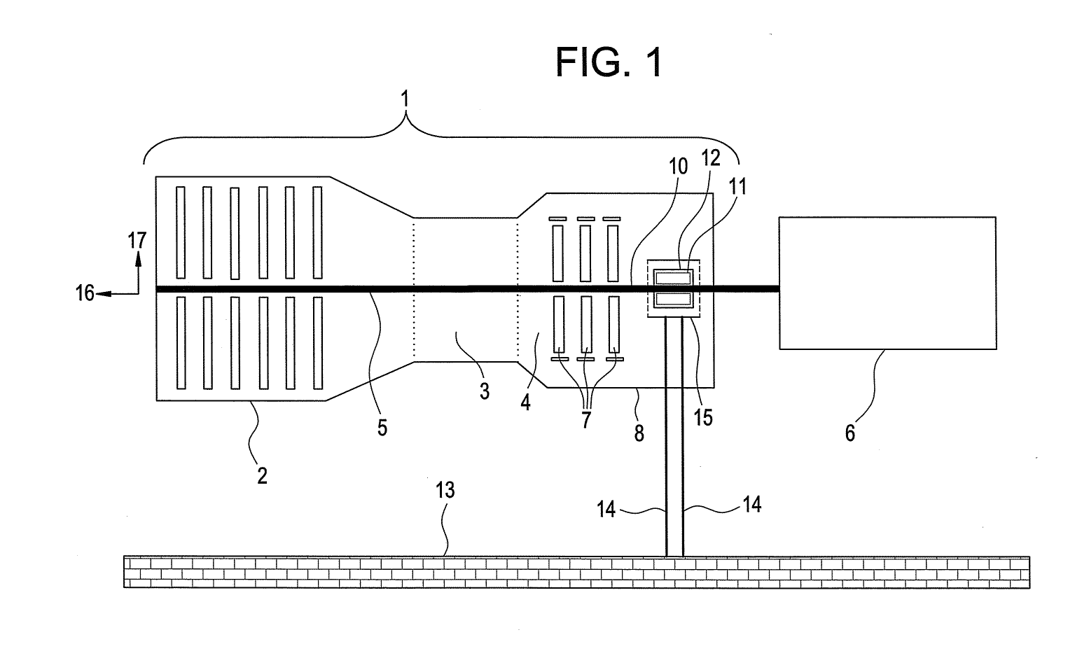

FIG. 1 illustrates an exemplary embodiment of a gas turbine 1. The gas turbine 1 includes a compressor 2, a combustion chamber 3, and a turbine 4. The compressor 2 is coupled to the turbine 4 by a shaft 5. In the embodiment of FIG. 1, the shaft 5 is also coupled to an electric generator 6. The turbine 4 includes turbine stages 7, and a casing 8 (also referred to as a stator 8). The shaft 5 coupled to the compressor 2 and the turbine stages 7 may be referred to as a rotor 10. The rotor 10 is supported by a rotor bearing 11. In the embodiment of FIG. 1, the rotor bearing 11 is supported by a bearing housing 12. The bearing housing 12 is supported by an inner barrel 15. In turn, the inner barrel 15 is supported by a support base 13 via support legs 14. The support base 13 includes stationary bases that can be located on the ground, such as a foundation, for example, and also mobile bases that can be disposed within an aircraft or a ship for example. FIG. 1 also shows a radial direction 17 representative of all radial directions normal to the shaft 5 and a longitudinal axis direction 16.

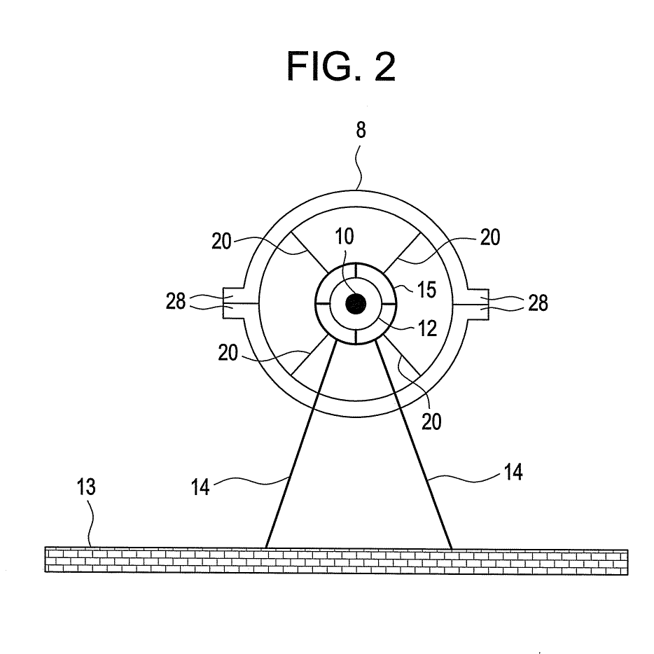

FIG. 2 illustrates an end view of an exemplary embodiment of the gas turbine 1. The view is in the longitudinal axis direction 16 with the blades of the turbine stages 7 removed for clarity. Referring to FIG. 2, the inner barrel 15 is depicted supporting the bearing housing 12. In the embodiment of FIG. 2, the inner barrel 15 is supported by two support legs 14. Also in the embodiment of FIG. 2, the casing 8 is supported by four struts 20. The four struts 20 are radially disposed from the inner barrel 15 to the casing 8. The casing 8 depicted in FIG. 2 includes two 180-degree segments coupled together by flanges 28. The four struts 20 maintain concentricity of the casing 8 with respect to the rotor 10. The concentricity is achieved by transferring forces imposed on the casing 8 to the support legs 14 via the struts 20. The forces may be transferred directly to the support legs 14 or through intermediate structures such as the inner barrel 15 or the bearing housing 12.

While an embodiment has been described having two support legs 14 and four struts 20, it will be appreciated that the scope of the teachings is not so limited. The teachings provide for embodiments having any number of support legs 14 and struts 20. The teachings also apply to the struts 20 being disposed in arrangements that may include intervening structures. Similarly, while the inner barrel 15 is depicted as supporting the bearing housing 12, the support legs 14 may be attached to at least one of the rotor bearing 11, the bearing housing 12 or to any structure supporting the bearing housing 12.

The embodiments described above depict the struts 20 coupled to the inner barrel 15. The teachings provide that the struts 20 may be coupled to the support legs 14 or an intervening structure that transfers forces from the struts 20 to the support legs 14. The intervening structure may be at least one of the inner barrel 15 and the bearing housing 12, for example.

While the embodiments presented in FIGS. 1 and 2 show the support legs 14 at the turbine 4 section of the gas turbine 1, a similar arrangement may be used to support the rotor 10 at the compressor section 2. The struts 20 may also be used to support the casing 8 at the compressor 2 section. When the support system is used at the turbine section 4 and the compressor section 2, concentricity of the rotor 10 with respect to the stator 8 may be improved over using the support system at just one section.

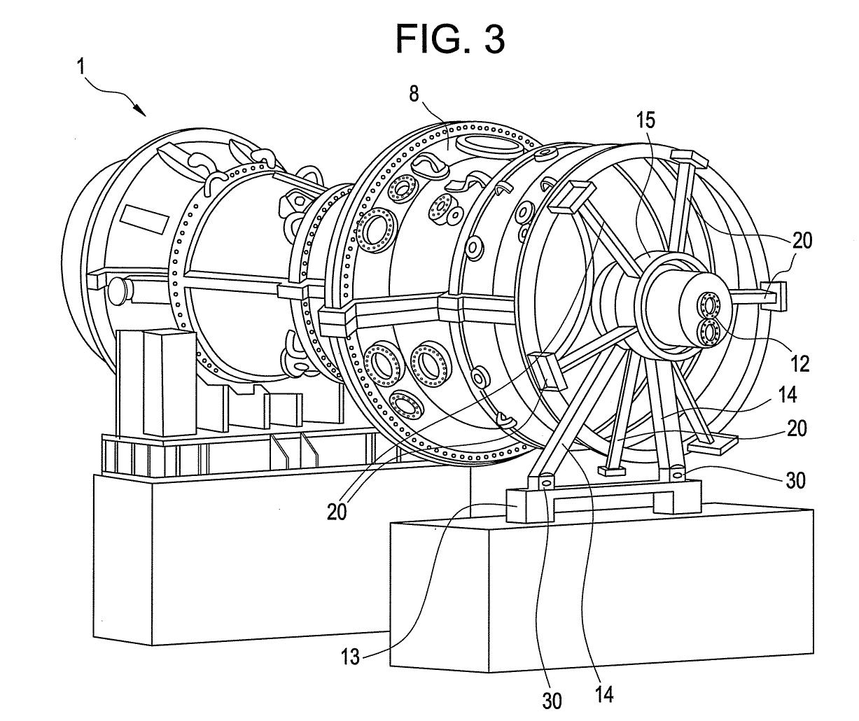

FIG. 3 presents a three dimensional view of another exemplary embodiment of the gas turbine 1 in which the casing 8 is supported by five of the struts 20. Referring to FIG. 3, the inner barrel 15 is supported by two of the support legs 14. In the embodiment of FIG. 3, each support leg 14 includes a coupling 30 for coupling each support leg 14 to the support base 13. The coupling 30 may be at least one of a rigid connection, a pivot connection, a sliding connection, and a spherical connection. The rigid connection provides for no movement of the support leg 14 relative to the support base 13. The pivot connection provides for rotational movement of the support leg 14 in one plane relative to the support base 13. The sliding connection provides for planar motion in a direction optimized to account for thermal growth of the support legs 14, the support base 13, and the inner barrel 15. The spherical connection provides for rotational movement of the support leg 14 in more than one plane relative to the support base 13.

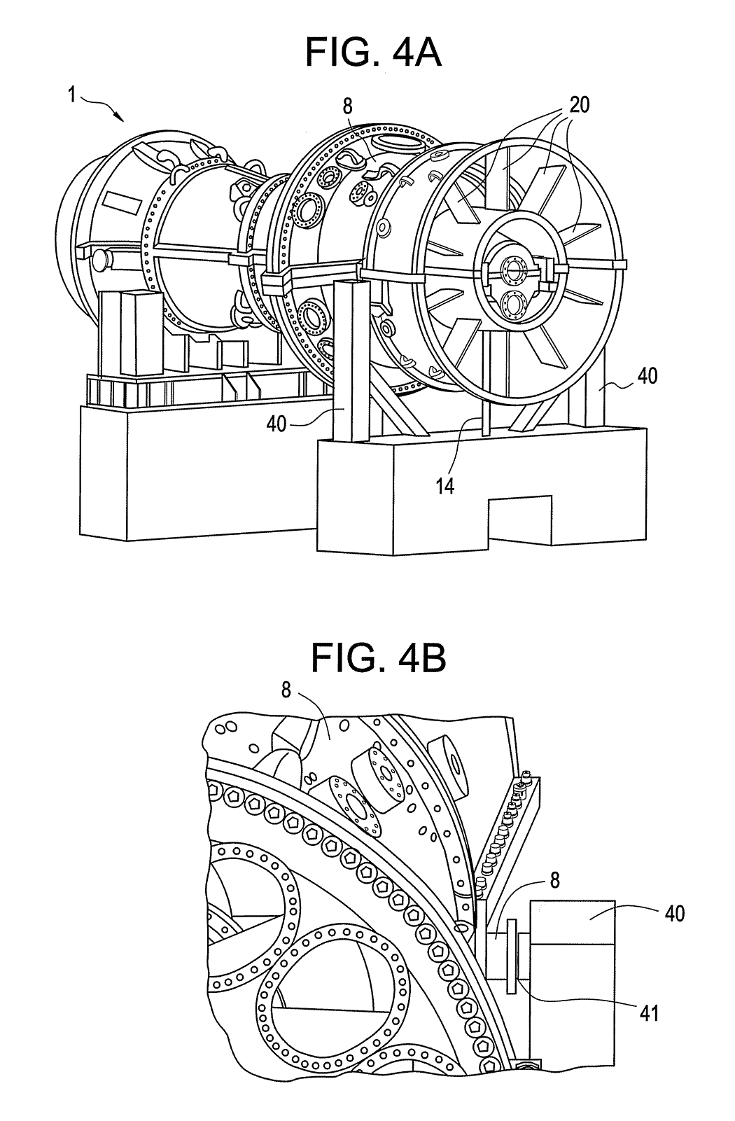

FIG. 4 presents an exemplary embodiment of the gas turbine 1 with one support leg 14. Referring to FIG. 4A, the support leg 14 is coupled to the support base 13 and the inner barrel 15. In embodiments where the support leg 14 does not provide desired lateral support, a lateral support structure may be used to provide the desired lateral support. FIG. 4A depicts a lateral support structure 40. The lateral support structure 40 limits lateral movement of the gas turbine 1. In the embodiment of FIG. 4, the lateral support structure 40 includes two parts where the two parts are disposed on generally opposite sides of the casing 8. FIG. 4B depicts a more detailed view of one part of the lateral support structure 40. Referring to FIG. 4B, a gap 41 is illustrated. The gap 41 is generally small and allows for growth of the gas turbine 1 in the longitudinal axis direction 16. An anti-friction material may be disposed on surfaces adjacent to the gap 41 to prevent friction from inhibiting growth of the gas turbine 1. Further, the lateral support structure 40 may include at least one of an active and a passive damper system to reduce vibration and associated fatigue in components of the lateral support structure 40

The support system provides several benefits. As discussed above, the support system provides concentricity of the rotor 10 with respect to the stator 8. The concentricity provides for maintaining alignment of the rotor 10 within the stator 8. Maintaining alignment reduces the risk of rubbing and subsequent damage to the gas turbine 1. Further, maintaining alignment may provide for less clearance requirements during operation with an associated increase in efficiency. During operation of the gas turbine 1 with the support system, adjustments are generally not required to maintain the alignment. Further, an active control system is not required to adjust supports to maintain the alignment. Another benefit of using the support system is that thinner struts 20 may be used relative to the struts 20 that would be required if the rotor 10 was supported from the stator 8. The thinner struts 20 provide less restriction to gas flow through the gas turbine 1. Less restriction to gas flow results in an improvement in efficiency of the gas turbine 1. Another benefit of using the support structure is improved rotor dynamics.

The embodiments of the support system presented above are with respect to supporting a gas turbine.

The embodiments and associated figures presented above provide examples of “direct” support of the rotor 10. Direct support of the rotor 10 does not generally include any support to be provided by the stator 8.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system to support a rotor and a stator of a rotating machine disposed upon a support base, the system comprising:
at least one support leg in operable communication with a bearing of the rotor and with the support base; and
at least one strut in operable communication with the at least one support leg and with the stator.

2. The system as in claim 1, wherein the rotating machine comprises a gas turbine.

3. The system as in claim 1, wherein the at least one strut and the at least one support leg are coupled to a housing supporting a rotor bearing of the machine.

4. The system as in claim 1, wherein the at least one strut and the at least one support leg are coupled to an inner barrel supporting a housing that supports a rotor bearing of the machine.

5. The system as in claim 1, wherein the at least one support leg comprises at least one of a rigid coupling, a pivot coupling, a sliding coupling and a spherical coupling.

6. The system as in claim 1, wherein the at least one strut comprises at least one of a rigid coupling, a pivot coupling, and a spherical coupling.

7. The system as in claim 1, further comprising a lateral support structure in operable communication with the stator and the support base.

8. The system as in claim 7, further comprising at least one of an anti-friction device and anti-friction material disposed between the lateral support structure and the stator.

9. The system as in claim 7, further comprising at least one of an active and a passive damping system.

10. A rotating machine disposed upon a support base, the machine comprising:
a stator;
a rotor disposed adjacent to the stator;
a rotor bearing in operable communication with the rotor;
at least one support leg in operable communication with the bearing and with the support base; and
at least one strut in operable communication with the at least one support leg and with the stator.

11. The machine as in claim 10, further comprising a housing in operable communication with the rotor bearing.

12. The machine as in claim 11, further comprising an inner barrel in operable communication with the housing.

13. The machine as in claim 10, further comprising a lateral support structure in operable communication with the stator and the support base.
